(19) United States
(12) Patent Application Publication
(10) Pub. No.: US 2025/0036722 A1
(43) Pub. Date: Jan. 30, 2025

(54) METHODS AND APPARATUS FOR IMPLEMENTING DIGITAL RIGHTS MANAGEMENT IN WEBRTC FOR ENCRYPTED REAL-TIME MEDIA TRANSMISSION

(71) Applicant: castLabs GmbH, Berlin (DE)

(72) Inventors: Vitaly Ivanov, Koh Samui (TH); Michael Stattmann, Berlin (DE)

(21) Appl. No.: 18/786,279

(22) Filed: Jul. 26, 2024

Related U.S. Application Data
(60) Provisional application No. 63/516,147, filed on Jul. 28, 2023.

(51) Int. Cl. G06F 21/10

(52) U.S. Cl. CPC G06F 21/1012; G06F 21/1013

(57) ABSTRACT

Embodiments provide a method for applying Digital Rights Management (DRM) protection to media such as compressed audio and video that is compatible with Real-time Transport Protocol (RTP) and conventional media processing pipelines without modification. Media is encrypted according to the Common Encryption Specification (ISO/IEC 23001-7) and frame-specific encryption metadata i.e. auxiliary encryption information is appended to the media frame. The encrypted media is transmitted in real-time over a network. On the receiving side, the encrypted media as well as auxiliary encryption information are extracted and forwarded to a content decryption module (CDM). The CDM uses the frame-specific encryption metadata to generate CencSampleAuxiliaryDataFormat and ISOBMFF boxes necessary for DRM license acquisition, acquires a DRM license with the decryption keys to decrypt and render media frames in a protected way.

### CROSS-REFERENCE TO RELATED APPLICATIONS

This application claims the benefit of priority to U.S. Provisional Patent Application Ser. No. 63/516,147 filed Jul. 28, 2023, entitled “Digital Rights Management for WebRTC”, the contents of which being incorporated herein by reference in its entirety.

### BACKGROUND

Media transmission frameworks often allow for transmission of data with low latency or bandwidth efficiency. They may also provide a standardized process of transmission, decoding and display. However, this workflow may not be able to benefit from pre-integrated security features on the client device that protect media, the media decryption and display from copying. This workflow incompatibility may stem from different priorities during the design phase or the fact that security protocols have been developed later.

In particular, in the case of Web Real-Time Communication (WebRTC), the decryption is commonly done in a way that does not protect the content from access on the client side using digital rights management (DRM) features and while this is not required for some applications, many applications would benefit from DRM protection on the client side.

However, the content format, meta information and decode/display workflow required by the Application Programming Interfaces (APIs) and processing components that are implemented in the common DRM ecosystem of today are not compatible with the standards required for efficient WebRTC media delivery, with the industry-wide consensus being that DRM for WebRTC is not supported using the existing implementations and ecosystem.

### SUMMARY

The present disclosure satisfies the foregoing needs by enabling, inter alia, DRM in WebRTC using DRM ecosystems in existence today.

Embodiments provide improvements to methods of media encryption and DRM implementation in a WebRTC framework. Frames are transformed, before transmission, such that they can be transmitted using the commonplace WebRTC framework and can be transformed again, on the receiving side, before decode, such that they can be processed using the secure DRM process that is commonplace on most of today's clients.

During streaming on the sending side media frames are encrypted and auxiliary encryption information required for Common Encryption (CENC) conforming decryption of media frames is packaged with the media frames in a format suitable for WebRTC media transmission and transmitted.

The encryption process on the sending side conforms to the CENC standards, so that the DRM on the client side is able to decrypt. CENC is the ISO/IEC 23001-7 Common Encryption specification, that uses encryption algorithms such as Advanced Encryption Standard (AES) with a 128-bit key, and modes such as Cipher Block Chaining (CBC) or Counter (CTR) modes.

The CencSampleAuxiliaryDataFormat of the CENC is a format specification for the storing of auxiliary data that is required for decryption. It includes the AES initialization vector and clear/encrypted byte ranges that may be generated and appended to the encrypted media frame as auxiliary encryption information.

On the receiving side, encrypted media is received via WebRTC using the Encoded Transform API. Next, the auxiliary encryption information is extracted and used to package the media into a format compatible with the Media Source Extensions (MSE) API. This will leverage the browser's Content Decryption Module (CDM) that can apply DRM and protect content decryption and display.

When the stream is started, a media initialization section is generated once, on the receiving side, at the beginning of the stream. It includes stream-wide information, and individual media fragments include single encrypted media frames with associated encryption metadata.

During streaming, each media frame is packaged and transmitted to the CDM, for a minimum delay.

In one aspect, a method of enabling Digital Rights Management (DRM) protection for media content, transmitted via a WebRTC compliant protocol is disclosed. In one embodiment, the method includes receiving the media content that is encrypted according to a protection scheme compatible with specifications of ISO/IEC 23001-7 via the WebRTC compliant protocol on a client; receiving auxiliary encryption information required for decryption; transforming the media content into data compliant with the specifications of ISO/IEC 23001-7 using the auxiliary encryption information, the data also including information necessary for DRM license acquisition; and submitting the data via World Wide Web Consortium Media Source Extensions (MSE) to a content decryption module for playback.

In one variant, the media content originates from a WebRTC source, is transmitted via a WebRTC Media Channel, and is processed with a WebRTC Encoded Transform.

In another variant, the client is a web browser.

In yet another variant, the auxiliary encryption information comprises an initialization vector, and information about the location of encrypted and unencrypted bytes.

In yet another variant, ISO/IEC 23001-7 compliant ISO base media file format (ISOBMFF) fragments containing a single frame are generated to be sent to the content decryption module of a browser using Media Source Extensions (MSE API).

In yet another variant, the media content is a stream of frames, referred to as access units in H.264/AVC, H.265/HEVC and H.266/VVC specifications, and temporal units in Alliance for Open Media (AOM) codecs like AOMedia Video 1 (AV1).

In yet another variant, additional dummy content is provided to a decoder.

In yet another variant, at least a portion of the auxiliary encryption information is received by reading it from data attached to a frame of the media content.

In yet another variant, the transforming of the media content includes undoing of start code prevention.

In yet another variant, the data compliant with the specifications of ISO/IEC 23001-7 includes CencSampleAuxiliaryDataFormat.

In yet another variant, the submitting of the data via MSE to the content decryption module for playback includes submitting data consisting of a single frame.

In another aspect, a transformer that includes a non-transitory computer-readable storage apparatus having a plurality of instructions, that when executed by a processor apparatus, are configured to: receive media content that is encrypted according to a protection scheme compatible with specifications of ISO/IEC 23001-7 via a WebRTC compliant protocol on a client; receive auxiliary encryption information required for decryption; transform the media content into data compliant with the specifications of ISO/IEC 23001-7 using the auxiliary encryption information, the data also including information necessary for DRM license acquisition; and submit the data via World Wide Web Consortium Media Source Extensions (MSE) to a content decryption module for playback.

In one variant, the media content originates from a WebRTC source, is transmitted via a WebRTC Media Channel, and is processed with a WebRTC Encoded Transform.

In another variant, the client is a web browser.

In yet another variant, the auxiliary encryption information comprises an initialization vector, and information about the location of encrypted and unencrypted bytes.

In yet another variant, the media content is a stream of frames, referred to as access units in H.264/AVC, H.265/HEVC and H.266/VVC specifications, and temporal units in Alliance for Open Media (AOM) codecs like AOMedia Video 1 (AV1).

In yet another variant, additional dummy content is provided to a decoder.

In yet another variant, at least a portion of the auxiliary encryption information is read from data attached to a frame of the media content.

In yet another variant, the data compliant with the specifications of ISO/IEC 23001-7 comprises CencSampleAuxiliaryDataFormat.

In yet another variant, the submission of the data via MSE to the content decryption module for playback comprises submission of data consisting of a single frame.

Other features and advantages of the present disclosure will immediately be recognized by persons of ordinary skill in the art with reference to the attached drawings and detailed description of exemplary implementations as given below.

### BRIEF DESCRIPTION OF DRAWINGS

The features, objectives, and advantages of the present disclosure will become more apparent from the detailed description set forth below when taken in conjunction with the drawings, wherein:

FIG. 1 is a schematic diagram showing a media distribution system, in accordance with the principles of the present disclosure.

FIG. 2 illustrates the unencrypted media exposure in a typical WebRTC transmission, in accordance with the principles of the present disclosure.

FIG. 3 illustrates end-to-end DRM protection of the media, in accordance with the principles of the present disclosure.

FIG. 4 illustrates the transformation applied to a H.264/AVC video stream, in accordance with the principles of the present disclosure.

FIG. 5 illustrates the process on the sending side, in accordance with the principles of the present disclosure.

FIG. 6 illustrates the workflow of DRM-protected WebRTC stream playback in a web browser, in accordance with the principles of the present disclosure.

FIG. 7 specifies the format of the auxiliary encryption information bundled with encrypted video frames, in accordance with the principles of the present disclosure.

FIG. 8 summarizes the process on the receiving side, in accordance with the principles of the present disclosure.

### DETAILED DESCRIPTION

WebRTC is an open framework for the web that enables Real-Time Communications (RTC) capabilities in a web browser. It provides a set of protocols and APIs that allow developers to incorporate real-time audio, video, and data sharing capabilities directly into web browsers. This eliminates the need for users to install additional software or plugins when engaging in RTC sessions.

With WebRTC, users can establish peer-to-peer connections that enable direct communication between browsers or devices without the need for intermediate servers. This decentralized architecture allows for low-latency, high-quality audio and video streaming, making it ideal for applications such as video conferencing, voice calling, live streaming, and file sharing.

WebRTC is supported by major web browsers, including Chrome, Firefox, Safari, and Edge, making it widely accessible across an array of different platforms. It utilizes a combination of open standards, including the RTC protocols developed by the Internet Engineering Task Force (IETF), such as Real-time Transport Protocol (RTP) and Interactive Connectivity Establishment (ICE). RTP includes the specification as in Request for Comment: RFC 3550 version 12 of July 2003, and ICE includes the specification as in RFC 8445 version 20 of July 2018, both of which are hereby incorporated by reference herein in their entireties.

In recent years, WebRTC has rapidly emerged as a de facto standard for ultra-low latency streaming, revolutionizing real-time communication over the web. Its inherent peer-to-peer architecture and support for real-time audio and video transmission make it particularly well-suited for applications that require minimal delays, such as live video streaming and interactive collaborations. By leveraging the direct communication capabilities of WebRTC, content providers and streaming platforms can bypass traditional media servers, reducing latency and improving the overall streaming experience. With WebRTC, end-users can enjoy near-instantaneous video playback and interactive engagement, enabling real-time interactions, live events, and interactive gaming experiences with minimal perceptible delay.

One of the key features of WebRTC is its ability to establish secure connections using encryption. It supports secure communication through the use of Transport Layer Security (TLS) and Datagram Transport Layer Security (DTLS) protocols, ensuring the privacy and integrity of data transmitted between peers.

While this kind of protection of the content in transmission is important, it does not control the use of the transmitted media after it has been received and decrypted by the client.

This protection is provided by a collection of technologies and practices that are collectively called DRM and broadly implemented in today's client devices.

However, because of a different file format and encryption protocol, WebRTC does not allow for DRM support which results in severe limitations on its use cases, particularly in the realm of premium content distribution and confidential communications.

DRM manages the rights of digital content creators, owners, distributors, and consumers. DRM systems are primarily employed to control and enforce restrictions on the access, use, and distribution of digital media such as music, movies, e-books, and software.

DRM enables content creators and distributors to define and enforce specific usage policies for their digital assets. These policies can include limitations on the how long or how often the content can be played back, the number of devices on which the content can be accessed, restrictions on copying or printing, security requirements for handling decrypted content and for safeguarding keys and the ability to expire or revoke access to content after a certain period or under specific conditions.

From a consumer perspective, DRM often manifests as software or hardware mechanisms embedded in devices, media players, or streaming platforms. These mechanisms authenticate the user, validate the license or subscription, and enforce the applicable usage rules defined by the content provider. This allows content creators and distributors to exercise control over their intellectual property and generate revenue by offering secure and licensed access to their digital content.

DRM technology plays a crucial role in safeguarding copyrighted material and ensuring that content creators can control and monetize their work effectively. They protect the content after it has been delivered and decrypted by the client from storage and redistribution by the client. Something that is crucial for some applications that use content of high value or confidential information and something that is not currently enabled with existing WebRTC implementations.

The typical purpose of DRM is to safeguard intellectual property rights and prevent unauthorized copying, sharing, or piracy of digital content. It achieves this through various means, some examples of which are outlined in the following:

Encryption will limit access to the protected content by requiring a decryption key, the availability of which can be controlled and limited to specific users, devices or times in order to control access. The keys can be delivered in connection with a license whose issuance is dependent on these factors and can be limited to, for example, specific registered devices that have been provisioned and have received a known private key, possibly at the time of manufacture or first use. Verification of the devices is often implemented in license servers run by DRM providers. Hardware decryption may be enforced to ensure that the decrypted content protected from unauthorized access to a higher degree than is common in software. The management of the decryption can also be implemented in an area with extra protection against eavesdropping and tampering such as a trusted execution environment. Secure decryption is often coupled with a secure video path that protects the content after decryption as well as after decoding to also provide protection from unauthorized access at this point.

Output controls enforce limitations to forward and display the content to display devices such as, for example, televisions (TVs) that provide a minimum-security standard in protecting the video signal before display. Other restrictions may limit the network types or distance that can be used to distribute the content and finally, signaling in the video and audio content can be used to embed robust messages in content that allows tracing of its origin or last legal recipient to identify a leak and possibly stop future leaks from the same source. Embedded messages that are imperceptible to the user are also known as digital watermarking.

These technologies require implementation from hardware manufacturers of video playback client devices and display devices like TVs and monitors, as well as video processing implementations of packagers, encoders/decoders, a content delivery network (CDN), web browsers and other entities across content distribution ecosystems.

Commercial DRM systems are, for example, offered by Google® under the Widevine brand, from Apple® as FairPlay Streaming, and Microsoft® as PlayReady. They manage keys provided to devices in hardware and/or software. They also assign levels of security depending on the level of implementation of some of the technologies.

The effective implementation of DRM requires interoperability between components from different manufacturers. These components span utilization starting at content creation and touch various elements in the ecosystem until the client. A set of standards has been created to enable interoperability. Most crucial for the application to protect the client during consumption of content transmitted with WebRTC are standards in the web browser. These include Encrypted Media Extensions (EME) which is based on Media Source Extensions (MSE) and provides APIs that enable communication between the most common web browser and the decryption module that is often implemented in the device hardware and is present in most mobile phones and other mobile devices on the market today that offer video playback ability of consumer content. Standards also include the International Organization for Standardization (ISO) base media file format (ISOBMFF) and CENC that are understood by the same secure and ubiquitously deployed playback infrastructure as well as by content encoders/packagers, content encryptors and content delivery networks.

MSE and EME are specified in World Wide Web Consortium (W3C) Recommendations: Media Source Extensions, W3C Working Draft 21 Sep. 2022 and Encrypted Media Extensions W3C Recommendation 18 Sep. 2017, respectively, the contents of which being incorporated herein by reference in its entirety. The ISOBMFF is standardized as International Organization for Standardization/International Electrotechnical Commission ISO/IEC 14496-12:2022 Information technology—Coding of audio-visual objects, Part 12: ISO base media file format, Edition 7, 2022, the contents of which being incorporated herein by reference in its entirety. CENC is standardized in the latest edition as ISO/IEC 23001-7:2023 Information technology—MPEG systems technologies, Part 7: Common encryption in ISO base media file format files, Edition 4, 2023, the contents of which being incorporated herein by reference in its entirety.

While the aforementioned DRM technologies and standards are most relevant in today's applications, they are exemplary for a general DRM system that may use different protection mechanisms and standards.

The standards that enable WebRTC are not only incompatible with DRM standards but also have limits in other critical security aspects.

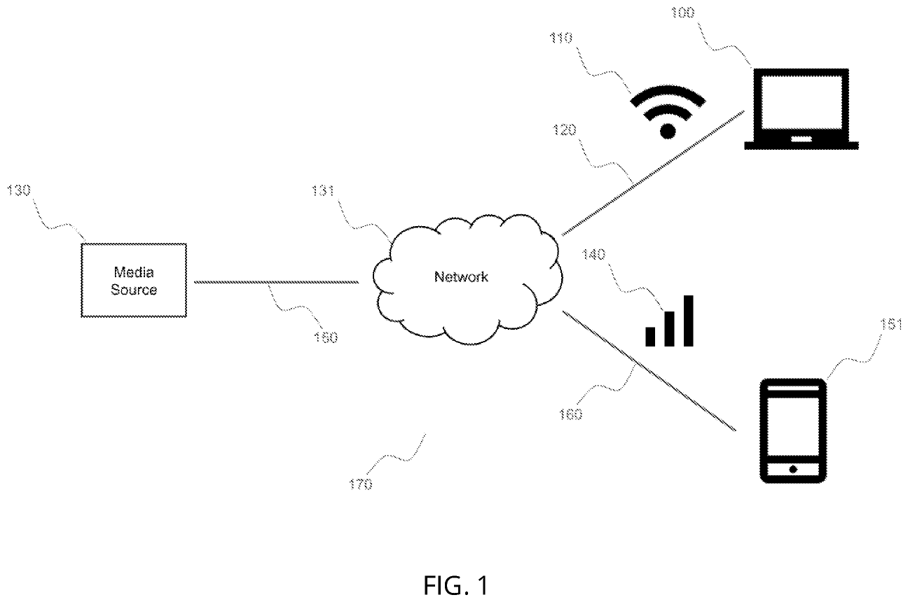

Developed with the goal of enabling seamless peer-to-peer communication, WebRTC provides a standardized framework for real-time audio and video transmission directly between web browsers. However, the rise of the Selective Forwarding Unit (SFU) architecture as the de facto standard for multi-party calls within WebRTC has brought attention to the issue of End-to-End Encryption (E2EE). While WebRTC itself supports (and mandates) encryption on a hop-by-hop basis, the media streams are vulnerable to interception or unauthorized access when passing through SFUs as shown in FIG. 1 since SFUs, in the vast majority of cases, are deployed on hardware belonging to public cloud server providers. The hop-by-hop basis stands for the fact that the media is encrypted in transit between the sender and the SFU, and between the SFU and the receiving client(s), but the SFU itself operates on unencrypted media inviting a man-in-the-middle attack during which a node that participates in the transmission can eavesdrop, record or alter the transmitted content without the knowledge of the communicating participants.

While significant progress has been made in the E2EE area with PERC (Privacy Enhanced RTP Conferencing), PERC Lite and SFrame specifications developed by IETF, DRM providing content protection benefits as outlined above, is something much harder to address since the workflow, including decryption, decoding and display has an incompatible implementation.

The present disclosure presented herein introduces valuable enhancements to address two key aspects: media encryption for protection of media during transmission and use of a DRM ecosystem within the WebRTC framework for protection of media after decryption on the client side.

One aspect offers an additional layer of media encryption that complements WebRTC's existing Datagram Transport Layer Security (DTLS) mechanism. This additional encryption layer is designed to seamlessly integrate with the current WebRTC infrastructure without causing any disruption or compatibility issues. By providing this supplementary encryption, the present disclosure enhances the overall security and confidentiality of real-time communication transmitted through WebRTC, ensuring that sensitive media (audio and video) remain protected from unauthorized access, recording or sharing during transmission.

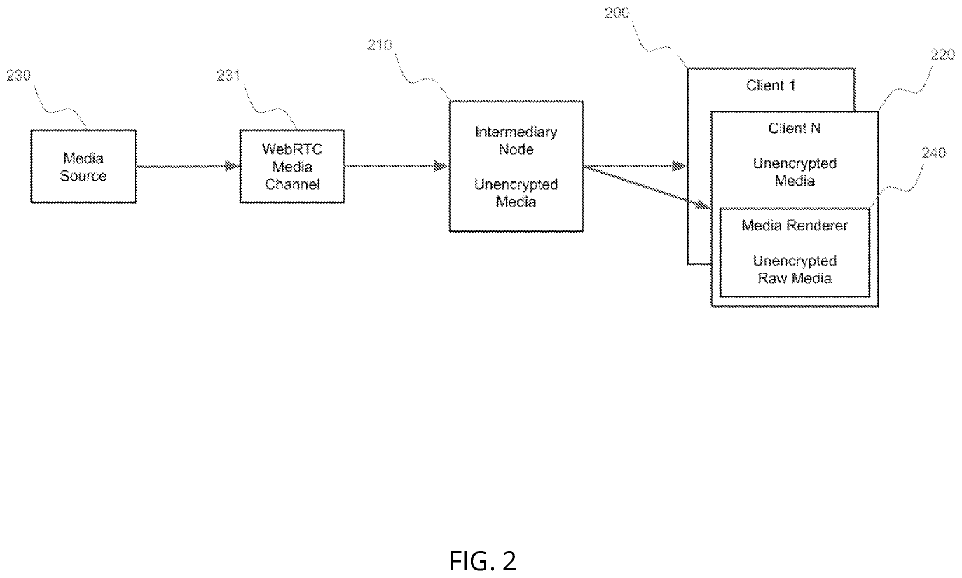

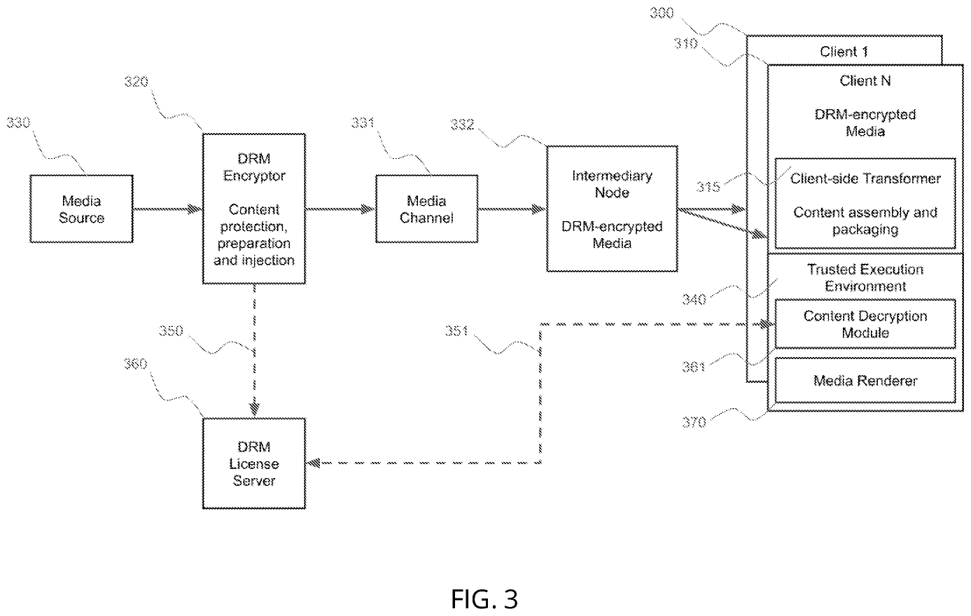

Specifically, the present disclosure enables E2EE between the stream producer and the consumer since intermediaries do not get access to the content while re-encrypting as is commonly the case today and shown in FIG. 2. Instead, nodes only get access to the headers necessary for media relaying, but not to the encrypted media itself, as shown in FIG. 3.

Additionally, the additional encryption layer is using a different set of keys and in some cases, algorithms and protocols, that will protect the content in case the other layer is compromised.

Another aspect of the present disclosure incorporates the DRM implementation on the receiving side, capitalizing on the capabilities of browser-based Content Decryption Modules (CDMs). Leveraging the robust security features and decryption capabilities offered by these pre-integrated browser CDMs, the present disclosure enables effective digital rights management for WebRTC-based content delivery as well as protection from unauthorized access, recording or sharing after transmission. In addition, it ensures that protected content transmitted via WebRTC is only accessible by authorized users with valid licenses or permissions, protecting the revenue of content distributors from content theft as well as protecting intellectual property rights of content owners and contributing to a secure and controlled content delivery ecosystem, leveraging modern and widespread implementation of DRM security features like hardware encryption, secure video path, and output control amongst others.

### Application Examples

The addition of DRM protection for transmission frameworks that have specific strength such as low latency, ubiquitous implementation or efficient bandwidth utilization but are not compatible to natively enable common DRM features, as described in this disclosure can be useful for any application that wants to use specific benefits of the transmission framework and in the same time leverage existing DRM features and enhanced encryption.

Examples include WebRTC transmission that is broadly implemented and enables low latency.

When used in, for example, the live streaming of events and performances whether it is concerts, sports matches, or educational seminars, WebRTC allows broadcasters to reach a global audience in real-time. Implementing DRM in these scenarios protects the intellectual property of the content creators and ensures that live streams are accessible only to authorized viewers who have purchased tickets or subscriptions and protects content from illegal recording and re-streaming.

WebRTC also plays a crucial role in online education and training platforms. By facilitating real-time video interactions between instructors and students, WebRTC enhances the learning experience through virtual classrooms and interactive sessions. Integrating DRM into these platforms safeguards valuable educational content from unauthorized access and distribution, ensuring that educators can monetize their courses effectively and prevent piracy.

WebRTC can also be used for low latency video conferencing and DRM is desirable for confidential communication to ensure that information discussed remains confidential and is not recorded on or forwarded from the receiving client device.

The presented disclosure discloses a novel set of methods that enable the use of modern Digital Rights Management (DRM) implementations for content transmitted using WebRTC.

### Systems for DRM Protected Content Streaming

An embodiment of a system in accordance with the principles of the present disclosure of application of DRM to low latency live streaming is shown in FIG. 1. The system 170 includes a streaming source 130 that is connected to a plurality of devices via a network 131. In the illustrated embodiment, the network is the internet and one of the devices connected to the network is a laptop computer 100 that is connected to the network via, for example, a Wi-Fi connection 110. Another device that is connected to the network is a smartphone 151 connected to the network via, for example, a cellular network 140.

The streaming source 130 provides a live, low latency media feed distributed to devices connected to the network. This may be in the format of media frames that may be combination or individual streams of media such as audio or video. In many embodiments, the transfer of media between the servers and the devices is secured using encryption in a way that is decryptable on the receiving end using a common DRM client. To enable the decryption by a common DRM client, the media is formatted on client devices 100, 151 before submitting for decryption.

Although the embodiment shown in FIG. 1 includes references to specific network, connection types and client hardware, different variations to transfer and consume content are applicable for the present disclosure.

The key challenge for enabling DRM-protected media distribution with low latency protocols like WebRTC is the lack of built-in support and standardization around it. Usually only hop-by-hop encryption based on DTLS is available, and this is not enough to provide neither E2EE nor DRM. The described disclosure closes this gap by providing a method to leverage existing DRM implementations in current web browsers by applying the CENC (Common Encryption) scheme to encoded media frames.

### Workflow Description

FIG. 2 shows an example workflow for media distribution using WebRTC, showing the exposure of unencrypted media during transmission in the current state of the art. The process begins with a Media Source 230 that generates the media content to be streamed. The media is transmitted via a WebRTC Media Channel 231 that is a part of WebRTC peer-to-peer connection to an Intermediary Node 210, which can be a Selective Forwarding Unit (SFU) or a fanout server, all of the above utilized to manage multi-party communication sessions.

The media content travels along the WebRTC Media Channel 231 encrypted, in a form of a Secure Real-time Transport Protocol (SRTP) stream, until it reaches a server, referred to as the Intermediary Node 210. The Intermediary Node 210 decrypts the media content, processes and re-encrypts it before forwarding the resulting media streams to the connected clients 200 and 220. There might be several Intermediary Nodes 210 cascade-connected to one another in large scale or geographically distributed streaming scenarios, with unencrypted media exposed at every intermediary node.

FIG. 2 also depicts the flow of the media from the Intermediary Node 210 to multiple clients 200, 220. As each client receives the media, it gets decrypted, decoded and sent to the Media Renderer 240 for playback. This process exposes the original unencrypted media sent from the Media Source 230 in the context of the receiving Client 200, 220, as well as raw (uncompressed) media as it's being rendered.

FIG. 2 illustrates the points of exposure of unencrypted media as it transits intermediary nodes 210 and is decoded and rendered in receiving clients, highlighting the need for additional security measures, such as E2EE and DRM, to protect the media content from eavesdropping and unauthorized copying.

FIG. 3 provides a high-level depiction of the presented disclosure. The purpose of the process is to use existing DRM functionality by using the browser CDM which provides benefits of a modern DRM client implementation including measures to ensure that the decryption key and decrypted media do not leave the Trusted Execution Environment (TEE), and therefore are not exposed to unauthorized copying. FIG. 3 is a general depiction that applies to media streaming including not only WebRTC but other frameworks like Media over QUIC as well as other standardized or proprietary audio or video streaming frameworks.

The present disclosure comprises two main components: a process on the sending side and a process on the receiving client's side, both aimed at implementing and enabling DRM.

The sending side process is encapsulated in the DRM Encryptor 320 that performs, in accordance with the invention, encryption of the media, such as compressed audio or video frames it receives from the Media Source 330. The encryption conforms with ISO/IEC 23001-7 Common Encryption in ISO Base Media File Format Files specification, referred to as the CENC specification hereafter. This specification is a de facto standard for implementation of modern DRM systems such as, for example, Google's Widevine, Apple's FairPlay Streaming, and Microsoft's PlayReady.

Prior to starting the encrypting of media frames, the DRM Encryptor 320 generates an encryption key and initialization vector and sends them over an encrypted network connection 350 (e.g., HTTPS) to a common DRM License Server 360, that stores the encryption key and assigns it a key identifier which is used for the issuance of decryption/playback license requests.

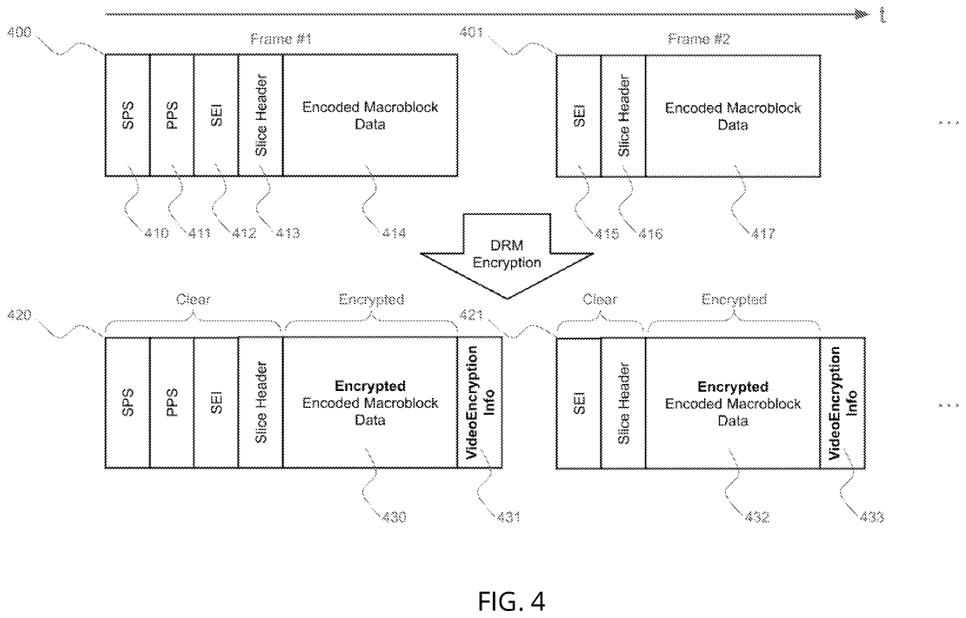

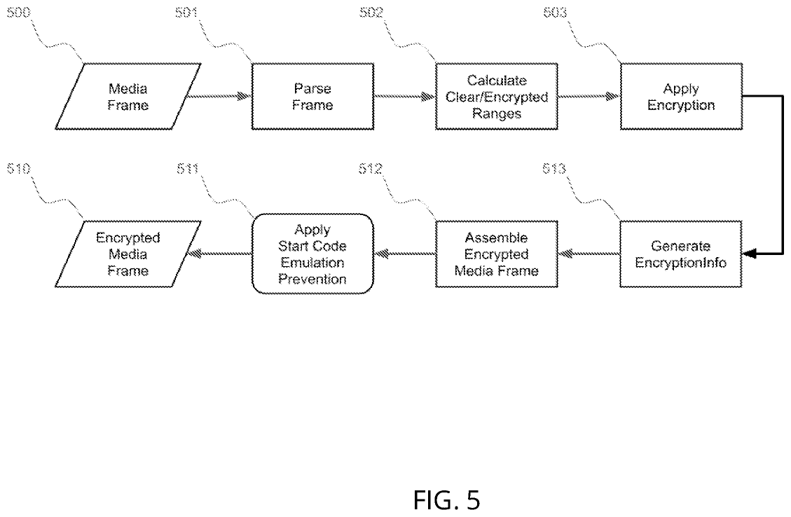

The DRM Encryptor/sender-side transformer 320 transforms the media for transmission as follows: it creates auxiliary encryption information needed for decryption, bundles it with the encrypted media frame in a way that is compatible with the targeted media transmission framework or indistinguishable from the media frame itself, as shown in detail in FIGS. 4 and 5. Next, the output of the DRM Encryptor 320 is passed to the Media Channel 331 for transmission to the receiving clients 300 and 310, possibly via one or several Intermediary Nodes 332. The Media Channel 331 and Intermediary Nodes 332 do not require to be modified and can be as in WebRTC Media Channel 231 and Intermediary Node 210 in FIG. 2. Each client 300 and 310 receives the same encrypted content but will need to get its own license for decryption.

The client-side methods include a transformation applied by 315 that encompasses the procedures of parsing of the incoming encrypted media frames, using the auxiliary information injected by the sending side and combining it with the content into a format that can be used by the Content Decryption Module (CDM) 361. The packaging process is done just-in-time, every time a new encrypted media frame is received, to ensure the lowest possible latency.

The packaged frame is passed to the standard conformant CDM 361 for further processing, which happens inside a common Trusted Execution Environment 350 (e.g., a hardware chip) securing the decryption key and decrypted media as it is being decoded and presented to the user by the Media Renderer 370.

The content assembly and packaging process depend on the type of the CDM 361 used: in the browser context wrapping of encrypted frames into fragmented mp4 (defined in ISO/IEC 14496-12 ISO Base Media File Format, ISOBMFF) is performed since that is the format supported by common browsers that implement the Media Source Extensions (MSE, or its iOS equivalent Managed Media Source) API. The encryption part of fragmented mp4 generation is fully conformant to the CENC specification, i.e. AES-128 in CBC and CTR modes is utilized, along with clear/encrypted ranges being signaled in accordance with the aforementioned specification.

The CDM of each client 361 sends a typical playback license request to the DRM License Server 360. The request may include intermediary proxies and allow the license server a verification of security levels and if the device and its owner is authorized to consume the content. It may contain implementation-specific (e.g., Widevine, FairPlay Streaming or PlayReady) data which usually includes basic client information pertaining to DRM like hardware and operating system identifiers, DRM type, decryption and output protection robustness, etc., all of these in encrypted form to eliminate any possibility of decryption key extraction by third parties.

Upon receiving the request, the DRM License Server 360 verifies the data provided and sends back a playback license containing information required for decryption, if all requirements are met.

FIG. 4 provides a visual representation of the DRM encryption application on the sending side and the layout of the output data of the DRM Encryptor, when operating on H.264/AVC (ISO/IEC 14496-10:2022 Information technology-Coding of audio-visual objects Part 10: Advanced video coding, published (Edition 10, 2022), the contents of which being incorporated herein by reference in its entirety, video frames. However, the scope of the present disclosure is not limited to H.264/AVC, and a generalized workflow suitable for any media codec is presented in FIG. 5.

The process depicted in FIG. 4 transforms unencrypted H.264/AVC video frames 400, 401 into DRM-encrypted video frames 420, 421 bundled with auxiliary data 431, 433.

In the preferred embodiment, the unencrypted frames 400, 401 comprise functional blocks called Network Abstraction Layer (NAL) units 410, 411, 412. NAL units can be separated into two general groups: Video Coding Layer (VCL) and non-VCL. VCL represents data which translates directly into rendered pixels, while non-VCL represents supplementary information needed for decoding (frame dimensions, bit depth, chroma sampling, entropy coding mode, etc.), displaying (aspect ratio, frame rate, etc.) or stream management in intermediary nodes.

In the preferred embodiment, only VCL data is encrypted, which is possible within CENC specifications and creates compatibility with the vast majority of modern DRM implementations. Another very important aspect of the present disclosure's encryption scheme is that by leaving non-VCL data intact, it makes DRM compatible with existing WebRTC implementations and pipelines without any changes required to support DRM, as long as there is no transcoding involved. Transcoding will fail due to the additional layer of encryption exerted by DRM, whereas typical operations performed by SFUs and fanout nodes will work as usual since they only parse and make decisions based solely on non-VCL data.

The encryption scheme is transport-agnostic, meaning that it is suitable not just for WebRTC and Real-time Transport Protocol (RTP), but also for any transport protocol or streaming framework, if the latter doesn't inspect or try to decode VCL data, which is usually the case.

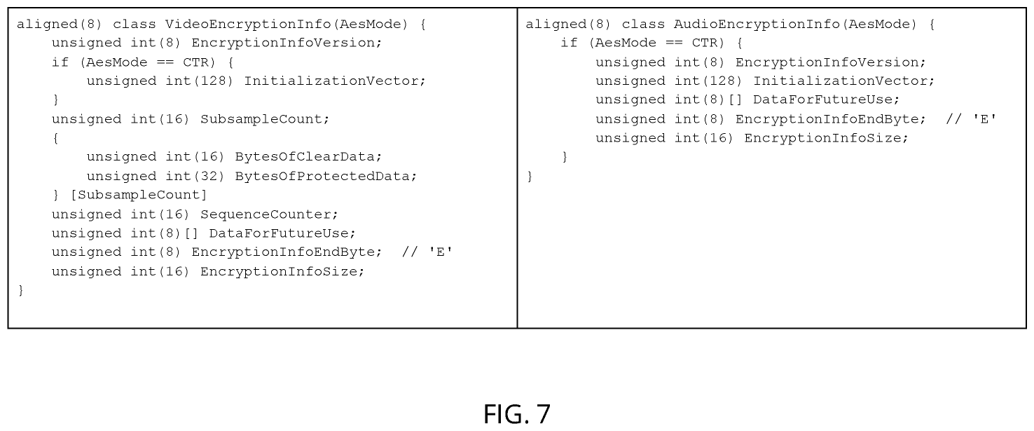

As stated above, non-VCL NAL units like Sequence Parameter Set (SPS) 410, Picture Parameter Set (PPS) 411, Supplemental Enhancement Information (SEI) 412, 415 as well as Slice Header 413, 416 are included in the clear (unencrypted) range of bytes, while the following Encoded Macroblock Data 414, 417 is encrypted and recorded as the encrypted range. The aforementioned ranges are utilized to form VideoEncryptionInfo structure 431, 433 (the format is presented in FIG. 7) that is appended to the resulting (encrypted) frame at the end of Encrypted Encoded Macroblock Data 430, 432. This VideoEncryptionInfo injection process is aimed at concealing it from non-DRM-aware WebRTC implementations and intermediary nodes since VideoEncryptionInfo will be indistinguishable from Encoded Macroblock Data, which is not parsed/processed, but rather forwarded as is. This may also require an additional transformation called start code/header emulation prevention which prevents the occurrence of specific codes that have a specific meaning during decode and therefore may not occur otherwise.

FIG. 5 illustrates the generalized process of the application of DRM encryption. The process of transforming the original unencrypted Media Frame 500 into the Encrypted Media Frame 510 starts with the Parse Frame 501 procedure, aiming at finding boundaries of non-VCL/header data. Then the process denoted by Calculate Clear/Encrypted Ranges 502 establishes clear/encrypted ranges based on the previous step.

At the next step Apply Encryption 503 Advanced Encryption Standard (AES) using Cipher Block Chaining (CBC) or Counter (CTR) modes with a 128-bit key, in conformance with the CENC specification, is applied to the encrypted data ranges. This is followed by Generate EncryptionInfo 513, where VideoEncryptionInfo or AudioEncryptionInfo, depending on the type of the media being processed, structure is filled in.

Next, the clear data ranges are combined with encrypted data ranges, following the original order of the Media Frame 500, and then the EncryptionInfo structure, produced in step 513, is appended to the end of the resulting frame to yield Encrypted Media Frame 510. This step is denoted by Assemble Encrypted Media Frame 512.

As a final step, the data may be prepared to allow for error free decoding on the client side. This may include Apply Start Code Emulation Prevention 511 if the media format requires it, with H.264/AVC, H.265/HEVC and H.266/VVC being typical examples. They forbid byte sequences like 00 00 01 in any point in the data of a media frame, since this is a special sequence utilized to signal the start of a NAL unit. If such sequence occurs in the encrypted media frame as a result of encryption or auxiliary data injection, it needs to be replaced (commonly referred as “escaped”). This process is described in detail in ISO/IEC 14496-10, section 7.4.1.1 Encapsulation of an SODB within an RBSP″, and it can be summarized as breaking down emulated start code sequences with a special byte 03, i.e. 00 00 01 is replaced with 00 00 03 01 on the sender side, and on the receiving side the sequence 00 00 03 is replaced with 00 00 in order to restore the data to its original state. Variations from this example of replacement of content for signaling or other purposes may be included in the transformation of this invention.

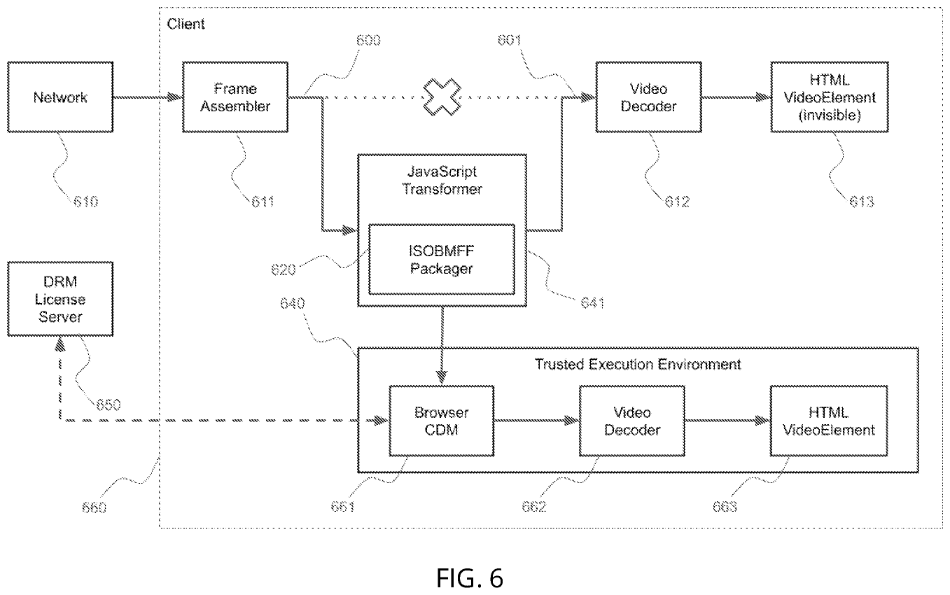

FIG. 6 illustrates the workflow of one embodiment of DRM-protected WebRTC stream playback in a web browser as in the present disclosure. For simplicity it only includes the video path—the audio path is either identical or, more commonly, the audio is left unencrypted, so there's no extra processing involved.

RTP packets arriving from the Network 610 and are assembled into video frames in the Frame Assembler 611 inside the Browser Client 660. In a regular non-DRM WebRTC scenario, the video or audio frames are sent to the Video Decoder 612 and after that are rendered with the HTMLVideoElement 613.

In aspects of the present disclosure, the Video Frames 600 cannot be sent to the Video Decoder 612 since they are DRM-encrypted. Instead, Encoded Transform API is utilized to forward them to the client-side Transformer 641 that, in the preferred embodiment, is implemented in JavaScript. The Encoded Transform API is specified in WebRTC Encoded Transform, W3C Working Draft, 13 Jul. 2023 which is hereby incorporated by reference herein in its entirety. In the client-side Transformer the auxiliary information is used, possibly decoded to remove start code/header emulation prevention, the content is packaged into a DRM conformant file format like ISOBMFF (620). This may include adding information for license acquisition, such as ISOBMFF boxes containing the DRM system identifier, decryption key identifier and initialization vector, as used in a common CENC-conformant CDM. The content is then dispatched to the Browser CDM 661.

The Browser CDM 661 interacts with the DRM License Server 650 to get a playback license as described in the annotation for FIG. 3. Secure decryption and rendering provided by the Browser CDM 661 follows, as implemented by the standard DRM on the device.

The WebRTC Encoded Transform API has been designed to allow for modification of the content transmitted with WebRTC. It allows developers to manipulate the encoded audio and video streams in real-time. Applications that this may be used for include, for example, Enhanced security using End-to-End Encryption (E2EE), by encrypting the media stream before it leaves the browser and decrypting it on the receiving end. The WebRTC Encoded Transform API is defined in the way that the client consuming the stream of frames is required to hand back decrypted frames after accessing them (this is depicted with the data flow arrow 601) for further processing by the rest of the WebRTC pipeline. This further processing includes decoding (612) and displaying (613) of video frames.

This is designed for the case of E2EE without DRM, however a secure DRM implementation will not make decrypted frames available, hence there is no data available to send to the Video Decoder 612. In this scenario, with no video frames arriving, the Video Decoder 612 and/or the rendering HTMLVideoElement 613 start issuing key frame requests assuming there was a transmission failure, which needs to be resolved with a key frame and decoding restart.

These requests cause the video encoder on the sending side to produce key frames recurrently and greatly increase bandwidth utilization due to the fact that key frames are typically significantly larger than predicted frames. As a result, both visual quality (encoding artifacts) and end-to-end latency can be affected in a vastly negative way.

The invention proposes a method of mitigating the key frame request mechanism of WebRTC: in order to satisfy the Video Decoder's 612 and the rendering HTMLVideoElement's 613 frame cadence requirements, the JavaScript Transformer 641 produces “dummy” video frames which can be successfully decoded and rendered, effectively blocking key frame requests. Output of the decoded “dummy” frames is suppressed or not displayed, for example, by means of sending them to HTMLVideoElement 613 for off-screen (hence the note “invisible”) rendering.

The content provided to the Video Decoder 612 in place of the unencrypted received content (“dummy” frames) may be pre-encoded and reused with any video stream as it doesn't need to contain any meaningful information or have anything in common with the actual video.

In the case when a frame is corrupted or lost in transmission due to, for example, network packet loss, the WebRTC's key frame request mechanism described above becomes necessary in order to resume decoding. The present disclosure describes a method triggering a key frame request with an intentionally corrupted “dummy” frame pushed via 601. Corrupted frames for such scenarios, just like valid “dummy” frames described in the previous paragraph, can be created on the client side on-the-fly or pre-encoded and mutated, and may be re-used for any corruption observed in the DRM decoding pipeline or the JavaScript Transformer 641. Here as throughout the disclosure frames can include video frames, audio frames or other media units that are processed or transferred together.

FIG. 7 specifies the format of the auxiliary encryption information bundled with encrypted video frames that is used in aspects of the present disclosure.

The auxiliary encryption information format is designed to be easily convertible to CencSampleAuxiliaryDataFormat described in the section 7.1 of the CENC specification. The portion of VideoEncryptionInfo including the fields InitializationVector, SubsampleCount, BytesOfClearData and BytesOfProtectedData is copied without modifications to the ISOBMFF ‘senc’ box in the ISOBMFF Packager 620. Descriptions of these fields can be found in the CENC specification.

SequenceCounter field of VideoEncryptionInfo is not a part of the CENC specification and was added in order to address the nature of reliability guarantees of low latency streaming protocols like WebRTC. Whereas the CENC specification defines encryption in the context of an ISOBMFF file, which is assumed to be delivered reliably over TCP or similar transport protocols, low latency streaming is usually built on top of UDP, and without reliable frame delivery guarantees. For that reason, the invention uses SequenceCounter field to detect missing video frames and trigger keyframe requests (as described in the annotation for FIG. 6).

For the case of audio (AudioEncryptionInfo), only the initialization vector is required since the full sample encryption is applied according to the section 9.4 of the CENC specification, and only if AES CTR mode is utilized. With AES CBC mode no audio auxiliary encryption information is generated.

The encryption process on the sending side, in aspects of the present disclosure, adheres to the ISO/IEC 23001-7: Common Encryption in ISO (the International Organization for Standardization) Base Media File Format Files specification. This specification defines the utilization of Advanced Encryption Standard (AES) using Cipher Block Chaining (CBC) or Counter (CTR) modes with a 128-bit key. These and other standard compliant encryption schemes may be supported by the present invention, depending on security requirements and client platform capabilities. CENC supports the option to encrypt some information while other information remains unencrypted. This information is required to be present at the decryption side to discern encrypted data from unencrypted data. The clear (unencrypted) and encrypted byte ranges are established and signaled accordingly. While this information has a specific location when using ISOBMFF, at this stage, there is no ISOBMFF wrapping, as such an action would necessitate a transition from the media-optimized RTCPeerConnection track to the general RTCDataChannel. RTCDataChannel's primary function is to deliver abstract data reliably and it might perform significantly worse in terms of latency than regular media tracks, in particular on bad network connections.

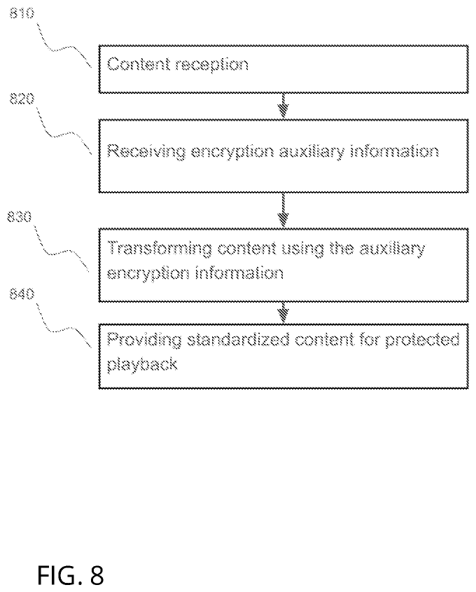

FIG. 8 provides a summary of the process on the client or receiving side of one embodiment of the present disclosure. The content is transmitted with a transmission protocol such as WebRTC. It may be received 810 using existing implementations present in the client device such as WebRTC implementations and frameworks present in web browsers. The received information is encrypted according to a protection scheme, meaning it is using specifying parameters like encryption algorithm, padding configuration and use of initialization vectors that are compliant with a scheme such as defined by CENC.

The media frames are extracted via World Wide Web Consortium (W3C) WebRTC Encoded Transform API, formerly known as Insertable Streams, supported by modern versions of Chrome, Edge, Firefox and Safari, and redirected to the browser CDM.

The client also receives auxiliary encryption information 820. This information may be transmitted in-band, along with the media content and/or out of band using a different transmission protocol or channel. Some information may also be hard-coded, i.e. using fixed values present in the application running in the application. The auxiliary encryption information is required for decryption and may contain information that is relevant for an entire stream or segments of it like individual frames. Auxiliary encryption information may include a choice of algorithm, initialization vectors, chaining mode, key length. Auxiliary encryption information may also include specification of where the encryption starts for a given frame. It may also include structural information about the media content that is necessary for decoding of the stream. In step 830 the content is transformed using the received content data and combining it with the received auxiliary information in order to transform the data from data that was compatible with the transmission with a transmission protocol like WebRTC to data compatible with DRM protected decryption such as data that is conforming to CENC and is transmitted via MSE API. The transformed data is transmitted in step 840 for secure DRM protected decryption and playback by, in one embodiment, a CDM.

Since browser CDMs do not currently support raw compressed media but need to be interfaced via the W3C Media Source Extensions (MSE) API, the data is packaged into a fragmented mp4 container that is accepted by the CDM. Every frame can be delivered as a separate fragment in order to achieve the lowest possible latency as the frame can be provided to the CDM without waiting for other frames to arrive. I.e. unlike the customary collection of frames packaged into a video fragment and downloaded before it is provided to the CDM the frame-by-frame packaging provides a just-in-time process that reduces delay because frames can be processed before subsequent frames are received by the client.

It will be recognized that while certain aspects of the present disclosure are described in terms of specific design examples, these descriptions are only illustrative of the broader methods of the disclosure and may be modified as required by the particular design. Certain steps may be rendered unnecessary or optional under certain circumstances. Additionally, certain steps or functionality may be added to the disclosed embodiments, or the order of performance of two or more steps permuted. All such variations are considered to be encompassed within the present disclosure described and claimed herein.

While the above detailed description has shown, described, and pointed out novel features of the present disclosure as applied to various embodiments, it will be understood that various omissions, substitutions, and changes in the form and details of the device or process illustrated may be made by those skilled in the art without departing from the principles of the present disclosure. The foregoing description is of the best mode presently contemplated of carrying out the present disclosure. This description is in no way meant to be limiting, but rather should be taken as illustrative of the general principles of the present disclosure. The scope of the present disclosure should be determined with reference to the claims.

1. A method of enabling Digital Rights Management (DRM) protection for media content, transmitted via a WebRTC compliant protocol, the method comprising:
receiving the media content that is encrypted according to a protection scheme compatible with specifications of ISO/IEC 23001-7 via the WebRTC compliant protocol on a client;
receiving auxiliary encryption information required for decryption;
transforming the media content into data compliant with the specifications of ISO/IEC 23001-7 using the auxiliary encryption information, the data also comprising information necessary for DRM license acquisition; and
submitting the data via World Wide Web Consortium Media Source Extensions (MSE) to a content decryption module for playback.

2. The method of claim 1, wherein the media content originates from a WebRTC source, is transmitted via a WebRTC Media Channel, and is processed with a WebRTC Encoded Transform.

3. The method of claim 1, wherein the client is a web browser.

4. The method of claim 1, wherein the auxiliary encryption information comprises an initialization vector, and information about the location of encrypted and unencrypted bytes.

5. The method of claim 1, wherein ISO/IEC 23001-7 compliant ISO base media file format (ISOBMFF) fragments containing a single frame are generated to be sent to the content decryption module of a browser using Media Source Extensions (MSE API).

6. The method of claim 1, wherein the media content is a stream of frames, referred to as access units in H.264/AVC, H.265/HEVC and H.266/VVC specifications, and temporal units in Alliance for Open Media (AOM) codecs like AOMedia Video 1 (AV1).

7. The method of claim 1, wherein additional dummy content is provided to a decoder.

8. The method of claim 1, wherein at least a portion of the auxiliary encryption information is received by reading it from data attached to a frame of the media content.

9. The method of claim 1, wherein the transforming of the media content comprises undoing of start code prevention.

10. The method of claim 1, wherein the data compliant with the specifications of ISO/IEC 23001-7 comprises CencSampleAuxiliaryDataFormat.

11. The method of claim 1, wherein the submitting of the data via MSE to the content decryption module for playback comprises submitting data consisting of a single frame.

12. A transformer comprising a non-transitory computer-readable storage apparatus comprising a plurality of instructions, that when executed by a processor apparatus, are configured to:
receive media content that is encrypted according to a protection scheme compatible with specifications of ISO/IEC 23001-7 via a WebRTC compliant protocol on a client;
receive auxiliary encryption information required for decryption;
transform the media content into data compliant with the specifications of ISO/IEC 23001-7 using the auxiliary encryption information, the data also comprising information necessary for DRM license acquisition; and
submit the data via World Wide Web Consortium Media Source Extensions (MSE) to a content decryption module for playback.

13. The non-transitory computer-readable storage apparatus of claim 12, wherein the media content originates from a WebRTC source, is transmitted via a WebRTC Media Channel, and is processed with a WebRTC Encoded Transform.

14. The non-transitory computer-readable storage apparatus of claim 12, wherein the client is a web browser.

15. The non-transitory computer-readable storage apparatus of claim 12, wherein the auxiliary encryption information comprises an initialization vector, and information about the location of encrypted and unencrypted bytes.

16. The non-transitory computer-readable storage apparatus of claim 12, wherein the media content is a stream of frames, referred to as access units in H.264/AVC, H.265/HEVC and H.266/VVC specifications, and temporal units in Alliance for Open Media (AOM) codecs like AOMedia Video 1 (AV1).

17. The non-transitory computer-readable storage apparatus of claim 12, wherein additional dummy content is provided to a decoder.

18. The non-transitory computer-readable storage apparatus of claim 12, wherein at least a portion of the auxiliary encryption information is read from data attached to a frame of the media content.

19. The non-transitory computer-readable storage apparatus of claim 12, wherein the data compliant with the specifications of ISO/IEC 23001-7 comprises CencSampleAuxiliaryDataFormat.

20. The non-transitory computer-readable storage apparatus of claim 12, wherein the submission of the data via MSE to the content decryption module for playback comprises submission of data consisting of a single frame.
